(19) United States
(12) Patent Application Publication
(10) Pub. No.: US 2022/0248512 A1
(43) Pub. Date: Aug. 4, 2022

(54) A CONTROL DEVICE FOR LIGHTING APPARATUS, CORRESPONDING LIGHTING APPARATUS, METHOD OF OPERATION AND COMPUTER PROGRAM PRODUCT

(71) Applicant: OSRAM GmbH, München (DE)

(72) Inventors: Alberto Alfier, Vedelago, Treviso (IT); Xiaolong Li, Montebelluna, Treviso (IT)

(21) Appl. No.: 17/627,004

(22) PCT Filed: Jul. 22, 2020
(86) PCT No.: PCT/IB2020/056878

§ 371 Date: Jan. 13, 2022

(30) Foreign Application Priority Data
Jul. 24, 2019 (IT) 102019000012726

(51) Int. Cl. H05B 45/22; H05B 45/10; H05B 47/18; H05B 47/155

(52) U.S. Cl. CPC H05B 45/22; H05B 47/155; H05B 47/18; H05B 45/10

(57) ABSTRACT

A control device for lighting apparatus includes a plurality of electrically-powered light radiation sources activatable to emit light radiations of different colors and produce a combined light radiation. The luminous flux intensities of the light radiation sources are adjustable to vary the color and the intensity of the combined light radiation.

### TECHNICAL FIELD

This disclosure relates to lighting apparatus. Examples are applicable to lighting systems for generating colored light, for example, in the field of show and entertainment.

### BACKGROUND

A traditional solution for generating colored light in the sector of show and entertainment (e.g., on a stage or a soundstage) is based on the use of optical filters.

Generally speaking, such filters are adapted to transmit light radiation selectively, by enabling the passage of only some fractions of the input light radiation, e.g., corresponding to one or more wavelengths or color ranges.

For example, by placing such filter in front of a conventional light radiation source such as a filament lamp or an arc lamp, the emission spectrum of the light radiation source is filtered to originate an output of colored light radiation.

When they are applied to stage lamps, the optical filters are often denoted as “gelatins.” Such filters or gelatins are available in a wide range of colors of the light radiation resulting from filtering.

On a level of practical implementation (considering, for example, the lighting of a theater stage) it is possible to obtain a combined light radiation by combining the light radiations emitted by a plurality of sources as described in the foregoing, each of which is equipped with a different optical filter.

For example, it is possible to make use of four such radiation sources to light the so-called “cyclorama” of a stage with 1 kW light radiation sources, e.g., halogen lamps, by associating thereto filters such as:
red L106—Cx 0.6940/Cy 0.3037;
green L122—Cx 0.3452/Cy 0.5503;
blue L363—Cx 0.1381/Cy 0.0980;
cold white L174—Cx 0.3004/Cy 0.3322.

Codes such as L106, L122, L363 and L174 correspond to the names normally employed by technicians (e.g., so called light directors or designers) to identify corresponding optical filters.

The previously listed Cx/Cy values identify the color points corresponding to the light radiations derived from the filtering action by the associated optical filter.

The previously mentioned Cx/Cy values refer, for example, to a color space such as CIE XYZ or CIE 1931. The color space defined by the International Commission on Illumination (CIE) in 1931 is widely acknowledged and used in the sector of lighting technology, which makes it unnecessary to provide a more detailed description herein.

Generally speaking, by combining various colored light radiations (for example, the four previously discussed kinds of light) it is possible, by dosing the relative intensities of such radiations, to generate a combined colored light radiations having color coordinates which are located (in the CIE 1931 diagram) in a region such as a triangle having a central white point, the apexes of the triangle corresponding to the red, green and blue radiations discussed in the foregoing.

With the introduction of solid-state (e.g., LED) lighting sources, i.e., with the so- called Solid State Lighting, SSL, technology, the possibility has arisen to reproduce the functionality of traditional optical filters by employing solid-state light radiation sources emitting light radiation at different lengths, by adjusting the intensities of the light radiation fluxes emitted by the individual sources, the radiations whereof are mixed or combined.

Such an operating principle is at the basis, e.g., of the commercially available product known as Cycliode Dalis-860 by Robert Juliat S.A.S. of Fresnoy-en-Thelle (France), or of the solution described in US 2003/189412 A1, wherein a set of LEDs is controlled to simulate the spectrum and/or the color of a single reference fixture (with or without color gelatin): the latter is a system adapted to reproduce a reference light beam having a given light beam color, with a static lighting producing a certain color but without additional functions.

### SUMMARY

We provide a control device for lighting apparatus including a plurality of electrically-powered light radiation sources activatable to emit light radiations of different colors and produce a combined light radiation, wherein luminous flux intensities of the light radiation sources of the plurality of electrically-powered light radiation sources are adjustable to vary the color of the combined light radiation, wherein the control device includes a user interface configured to receive optical filter selection signals, wherein the optical filter selection signals are combinable in a plurality of user-selectable combinations adapted to produce respective colors of the combined light radiation, a conversion module configured to convert the optical filter selection signals into respective sets of luminous flux intensity values of the light radiation sources of the plurality of electrically-powered light radiation sources, wherein the conversion module is configured to convert the plurality of user-selectable combinations into a respective plurality of combinations of luminous flux intensities of the light radiation sources of the plurality of electrically-powered light radiation sources and adjust the luminous flux intensities of the light radiation sources of the plurality of electrically-powered light radiation sources to vary the color of the combined light radiation as a function of user-selected combinations of the optical filter selection signals out of the plurality of user-selectable combinations adapted to produce respective colors of the combined light radiation.

We also provide a lighting apparatus including a plurality of electrically-powered light radiation sources configured to emit light radiations of different colors and produce a combined output light radiation, drive circuitry for the plurality of electrically-powered light radiation sources, the drive circuitry configured to adjust the luminous flux intensities of the light radiation sources of the plurality of electrically-powered light radiation sources to vary the color of the combined light radiation, the control device for lighting apparatus including a plurality of electrically-powered light radiation sources activatable to emit light radiations of different colors and produce a combined light radiation, wherein luminous flux intensities of the light radiation sources of the plurality of electrically-powered light radiation sources are adjustable to vary the color of the combined light radiation, wherein the control device includes a user interface configured to receive optical filter selection signals, wherein the optical filter selection signals are combinable in a plurality of user-selectable combinations adapted to produce respective colors of the combined light radiation, a conversion module configured to convert the optical filter selection signals into respective sets of luminous flux intensity values of the light radiation sources of the plurality of electrically-powered light radiation sources, wherein the conversion module is configured to convert the plurality of user-selectable combinations into a respective plurality of combinations of luminous flux intensities of the light radiation sources of the plurality of electrically-powered light radiation sources and adjust the luminous flux intensities of the light radiation sources of the plurality of electrically-powered light radiation sources to vary the color of the combined light radiation as a function of user-selected combinations of the optical filter selection signals out of the plurality of user-selectable combinations adapted to produce respective colors of the combined light radiation, having the conversion module coupled to the drive circuitry to provide the drive circuitry with the respective combinations of luminous flux intensities of the light radiation sources of the plurality of electrically-powered light radiation sources to vary the color of the combined light radiation as a function of user-selected combinations of the optical filter selection signals out of the plurality of user-selectable combinations adapted to produce respective colors of the combined light radiation.

We further provide a method of operating the control device for lighting apparatus including a plurality of electrically-powered light radiation sources activatable to emit light radiations of different colors and produce a combined light radiation, wherein luminous flux intensities of the light radiation sources of the plurality of electrically-powered light radiation sources are adjustable to vary the color of the combined light radiation, wherein the control device includes a user interface configured to receive optical filter selection signals, wherein the optical filter selection signals are combinable in a plurality of user-selectable combinations adapted to produce respective colors of the combined light radiation, a conversion module configured to convert the optical filter selection signals into respective sets of luminous flux intensity values of the light radiation sources of the plurality of electrically-powered light radiation sources, wherein the conversion module is configured to convert the plurality of user-selectable combinations into a respective plurality of combinations of luminous flux intensities of the light radiation sources of the plurality of electrically-powered light radiation sources and adjust the luminous flux intensities of the light radiation sources of the plurality of electrically-powered light radiation sources to vary the color of the combined light radiation as a function of user-selected combinations of the optical filter selection signals out of the plurality of user-selectable combinations adapted to produce respective colors of the combined light radiation, the method comprising receiving at the user interface user-selected combinations of the optical filter selection signals out of the plurality of user-selectable combinations adapted to produce respective colors of the combined light radiation, converting at the conversion module the user-selected combinations of the optical filter selection signals subsequently received at the user interface into respective sets of luminous flux intensity values of the light radiation sources of the plurality of electrically-powered light radiation sources.

We also further provide the method of operating the control device for lighting apparatus including a plurality of electrically-powered light radiation sources activatable to emit light radiations of different colors and produce a combined light radiation, wherein luminous flux intensities of the light radiation sources of the plurality of electrically-powered light radiation sources are adjustable to vary the color of the combined light radiation, wherein the control device includes a user interface configured to receive optical filter selection signals, wherein the optical filter selection signals are combinable in a plurality of user-selectable combinations adapted to produce respective colors of the combined light radiation, a conversion module configured to convert the optical filter selection signals into respective sets of luminous flux intensity values of the light radiation sources of the plurality of electrically-powered light radiation sources, wherein the conversion module is configured to convert the plurality of user-selectable combinations into a respective plurality of combinations of luminous flux intensities of the light radiation sources of the plurality of electrically-powered light radiation sources and adjust the luminous flux intensities of the light radiation sources of the plurality of electrically-powered light radiation sources to vary the color of the combined light radiation as a function of user-selected combinations of the optical filter selection signals out of the plurality of user-selectable combinations adapted to produce respective colors of the combined light radiation, the method comprising receiving at the user interface user-selected combinations of the optical filter selection signals out of the plurality of user-selectable combinations adapted to produce respective colors of the combined light radiation, converting at the conversion module the user-selected combinations of the optical filter selection signals subsequently received at the user interface into respective sets of luminous flux intensity values of the light radiation sources of the plurality of electrically-powered light radiation sources, further including receiving at the user interface at least one test combination of the optical filter selection signals out of the plurality of user-selectable combinations adapted to produce respective colors of the combined light radiation, detecting a color of the combined light radiation produced by the plurality of electrically-powered light radiation sources as a function of the test combination of the optical filter selection signals and measuring an offset of the color detected with respect to a target color for the combined light radiation, and producing an output signal indicative of the measured offset, and further including providing in the conversion module a set of adjustable conversion parameters top convert the optical filter selection signals into respective sets of luminous flux intensity values of the light radiation sources of the plurality of electrically-powered light radiation sources, and adjusting conversion parameters in the set of adjustable conversion parameters in the conversion module to reduce the measured offset.

### BRIEF DESCRIPTION OF THE DRAWINGS

FIG. 1 shows, with reference to a CIE XYZ or CIE 1931 color space, the possibility of generating colored light radiation by combining a plurality of light radiations having different colors.

FIG. 2 is a flowchart exemplifying possible actions which may be taken in that context.

FIG. 3 is a further flowchart exemplifying possible actions in examples.

FIG. 4 is a block diagram of a system adapted to include one or mor examples.

### LIST OF REFERENCE SIGNS

| Light radiations | A, B, C, D, E, F |
|---|---|
| Light radiation sources | S_{A}, S_{B}, S_{C}, S_{D}, S_{E}, S_{F} |
| Lighting device | 10 |
| Conversion module | 14 |
| Optical filter selection signals | L106, L122, L124, L363 |
| Temperature sensor | T |
| Colorimeter | CM |
| Digital filter selection | 100 |
| Identification of weighting coefficients | 102 |
| Keeping of flux intensity ratios | 104 |
| Selection of optical filters/intensities | 200 |
| Determination of conversion coefficients | 202 |
| Data processing/Radiation generation | 204 |
| Keeping of flux intensity ratios | 206 |
| Repetition 200, 202, 204 and 206 | 208 |

### DETAILED DESCRIPTION

One or more examples further develop the usage possibilities of such systems based on solid-state light radiation sources, for example, by simplifying the use thereof by operators who are accustomed to systems based on optical filters.

According to one or more examples, simplification may be achieved thanks to a control device for lighting apparatus.

One or more examples may refer to a corresponding lighting apparatus.

One or more examples may refer to a corresponding method of operation.

One or more examples may refer to a corresponding computer program product, which may be loaded into the memory of at least one processing circuit and which includes software code portions that execute the steps of our methods when the product is run on at least one processing circuit.

As used herein, the reference to such a computer program product is to be construed as a reference to a processor-readable medium containing instructions for controlling the processing system, with the aim of coordinating the implementation of our methods.

One or more examples may simplify the activity of technicians such as light designers, by adopting, instead of traditional lighting systems (e.g., with halogen sources), systems with solid-state light radiation sources, wherein the possibility is given of reproducing conventional adjustments achieved through optical filters so that the technicians may take advantage of their previous experience.

One or more examples may achieve such simplification without introducing difficulties concerning possible aspects of a solid-state lighting system, specifically by enabling an operator to use a system with solid-state sources by adopting a traditional approach, i.e., by working on color channels with related (flux) intensity values for each channel.

One or more examples moreover enable taking advantage of the possibility, offered by digital filters consisting in solid-state sources, to implement a function which may be defined as a “dynamic digital filter” with smooth transitions, i.e., without sudden leaps, between two different colors of combined light radiation given by a combination of two or more different colors of digital filters: this is a function which makes it easier to reproduce with accuracy the effects achievable through systems based on traditional optical filters.

One or more examples help reproduce, with LED fixtures, the behavior of traditional systems (which the light designers are accustomed to), while taking advantage of a dynamic digital filter adapted to reproduce the same effect both as regards color output and as regards, e.g., the usage of a console for controlling the fixture (by simply acting on cursors and sliders for adjusting intensity, once the desired digital filters have been selected).

In short, one or more examples may enable concurrently:

reproducing the operation of traditional optical filter systems, both as regards the lighting results and as regards the usage;

leveraging the transition from optical filter systems to “digital filter” systems such as those based on the use of solid-state light radiation sources.

In one or more examples, such result may be achieved either by features embedded in the lighting device or by transferring, partly or completely, such features to a control station such as a console, or optionally to an interface such as, e.g., a so-called “app.”

One or more examples offer the possibility, within one and the same LED “fixture,” of selecting a plurality of color gelatins, with a control device adapted to cause the fixture to reproduce the combination of the results of the selected gelatins, by dynamically generating a light beam which may vary on the basis of the filter/gelatin selection and of the mixing intensities.

In the following description, various specific details are given to provide a thorough understanding of representative examples. The examples may be implemented without one or several specific details, or with other methods, components, materials or the like. In other instances, well-known operations, materials or structures are not shown or described in detail to avoid obscuring certain aspects of the examples.

Reference to “an example” or “one example” means that a particular feature, structure or characteristic described in connection with the example is included in at least one example. Thus, the possible appearances of the phrases “in an example” or “in one example” in various places are not necessarily all referring to one and the same specific example. Furthermore, particular features, structures or characteristics may be combined in any suitable manner in one or more examples.

The headings provided herein are given for convenience only, and therefore do not interpret the extent of protection or scope of the examples.

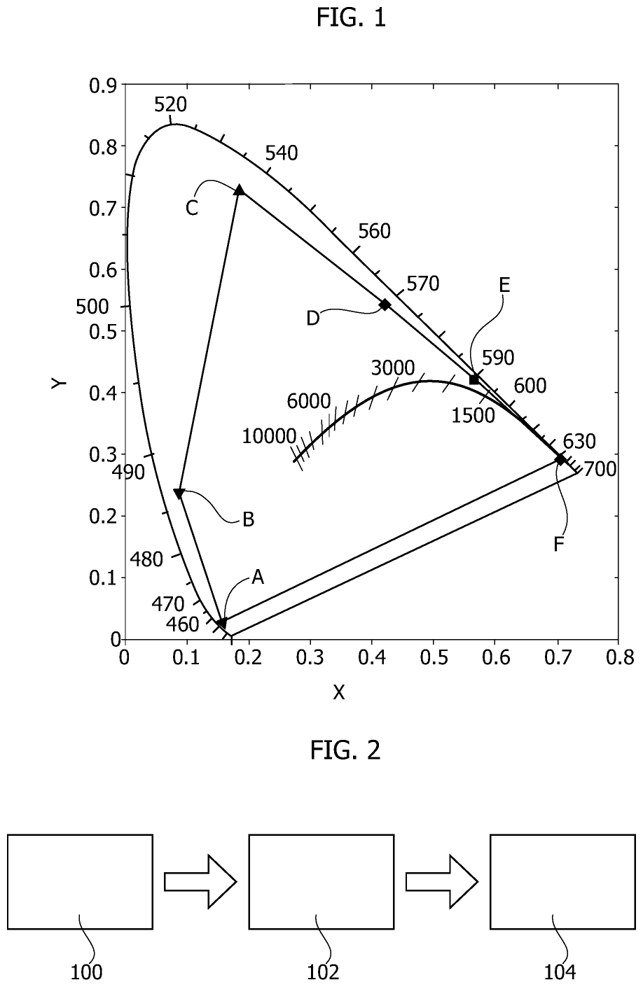

FIG. 1 exemplifies the possibility of generating colored light radiation by combining a certain number of light radiations, which are combined or mixed (in any manner known).

FIG. 1 exemplifies the possibility of generating colored light radiation corresponding to a color point having general coordinates Cx, Cy included in a polygonal hexagonal area having vertexes A, B, C, D, E and F in a CIE XYZ or CIE 1931 color space.

The vertexes are given by the color points which identify, in the color space, the light radiations emitted by a given number (e.g., six) of light radiation sources which are combined or mixed.

For example, the light radiations being combined may correspond to colors such as:
A=Royal Blue (RB),
B=Cyan,
C=Green,
D=Lime (Phosphor Converted Green),
E=Amber, and
F=Red.

In an example such as shown in FIG. 1 (which is therefore only exemplary), the light radiations of the colors blue, cyan, green and red may be generated by LED sources with direct emission, while radiations D and E may be generated by phosphor-converted LED source emitters (PCG and PCA).

At any rate, it will be appreciated that referring to the possible combination of six radiations (such as the radiations corresponding to color points A, B, C, D, E and F) is merely exemplary: such a result may be achieved with any number of light radiations (i.e., N radiations with N≥2): for example, the Dalis-860 product, mentioned in the introduction, envisages using LED sources of eight different colors.

A solution as exemplified in FIG. 1 may be implemented through the actions exemplified in the flowchart of FIG. 2, wherein block 100 corresponds to the selection of a “digital filter,” i.e., to the choice of the color coordinates Cx, Cy of the colored radiation which is to be obtained by combination. This action may be considered as a sort of (virtual) definition of the colors of a given number of optical filters, adapted to originate a desired colored radiation.

Action 102 corresponds to identifying weighting coefficients which, being applied to the luminous fluxes of the various radiations A, B, C, D, E and F, enable originating, by combining (mixing) such light radiations, a combined light radiation having a desired color.

It will be appreciated that, in addition to the desired color (making it impossible to notice a difference between the traditional system and the LED system), one or more examples may also offer, at least optionally, the possibility of making the shape of the resulting spectrum obtained by the LED system closely resemble the shape of a spectrum achievable via a traditional system based on filters. In this respect, one or more examples may take advantage of the fact that obtaining a given color point and a given spectrum involves using N values of flux intensity, the flux ratios for achieving one (single) color point differing from the flux ratios necessary for obtaining in addition a spectrum having a certain shape.

In practice, action 102 corresponds to defining a set of N values of flux intensity, wherein N is the number of “elementary” radiations A, B, C, D, E, F (for a total of six in the presently considered example).

A further function, exemplified by block 104, enables (in a fashion known in itself) keeping the ratios among the various flux intensities of the mixed radiations constant to prevent undesired variations (drifts) of the color of the combined light radiation. Such phenomena are due, e.g., to variations of the emission wavelength of the individual sources, and/or to a decrease of the flux intensities of radiations A, B, C, D, E, F, which may be due, e.g., to a change in temperature.

The Table below exemplifies, on the right side, the possibility, offered by the actions exemplified in FIG. 2, of adjusting the various radiations A, B, C, D, E, F to different intensity levels of the emitted luminous flux.

| | | F | E | D | C | B | A |
|---|---|---|---|---|---|---|---|
| L106 | Primary | 100% | 17% | 0% | 0% | 0% | 0% |
| | Red | | | | | | |
| L122 | Fern | 0% | 0% | 100% | 42% | 6% | 0% |
| | Green | | | | | | |
| L363 | Special | 0% | 0% | 0% | 8% | 100% | 58% |
| | Medium | | | | | | |
| | Blue | | | | | | |
| L174 | DK | 17% | 81% | 100% | 78% | 37% | 17% |
| | Steel | | | | | | |
| | Blue | | | | | | |

Such result may be achieved, e.g., by acting, in a fashion known in itself, on the duty cycle of the drive current of the (e.g., LED) light sources generating radiations A, B, C, D, E and F, to enable generating, e.g., on the basis of six color channels, a colored light radiation identical to what would be obtained by applying optical filters or gelatins to filament or arc sources, e.g., (with reference to the Table above, which includes four colors) with four filters or gelatins applied onto four filament or arc sources. One or more examples may enable, for example:

reproducing, with six LEDs, colors L106, L122, L363 or L174 (as listed in the Table above) individually, i.e., as they may be traditionally obtained with a single gelatin (e.g., L106) applied onto a filament source, therefore reproducing the color of the individual gelatin traditionally applied onto filament sources;

by assuming the presence of a plurality of filament systems (e.g., four), each having a different gelatin applied thereon (for example, four light sources with the four gelatins L106, L122, L363 and L174 applied thereon), lighting with the six LEDs one and the same point with a mixed color.

Therefore, one or more examples offer the possibility to overcome limits such as imposed by the need of reproducing only single colors of different gelatins, or by the possible transitions among different filters, which are processed by the firmware of the fixture and cannot be easily controlled by the user.

Of course, the reference to six color channels and to four filters or gelatins is merely exemplary.

By acting on the intensities associated with the various color channels, it is possible to generate light radiation corresponding to any color point included in the polygon having vertexes A, B, C, D, E and F of FIG. 1, especially the color points corresponding to the majority of commercially available gelatins.

It will moreover be appreciated that, while this description refers by way of example to a CIE XYZ or CIE 1931 color space, the same considerations are applicable to other color spaces such as an RBG color space. Because the RBG color space may be considered as a sub-space of the CIE 1931 color space, in such an instance it is possible to reproduce, instead of the colors enclosed by polygon ABCDEF in FIG. 1, only the colors enclosed by triangle ACF.

The Table above moreover exemplifies the possibility offered by a “digital filter” including six color channels to synthesize, e.g., four (again, this number is merely exemplary) optical filters corresponding to the colors known as Primary Red, Fern Green, Special Medium Blue and Dark Steel Blue, i.e., the colors of four traditional optical filters commonly identified by the codes L106, L122, L363 and L174.

Some cells in the right part of the Table above contain a value equal to 0%, which indicates that a given radiation does not take part to the synthesis of a certain filter. For example, with reference to the first line of the Table, it is possible that the four radiations A, B, C, D do not take part to the synthesis of Primary Red (L106), which derives from a combination of 100% Red (radiation F) and 17% Amber or PCA (radiation E).

It will moreover be appreciated that the quantitative values are expressed as a function of a mutual ratio (17%:100%, for example, with reference to typical flux values which may be associated to such colors presently available on the market).

One or more examples may therefore be based on the recognition (expressed by way of example in the Table above) that the color of a given optical filter, e.g., L106, L122, L363 or L174 may be reproduced by a “digital filter,” i.e., via a combination of weighting coefficients expressing the flux intensity ratios of the radiations emitted by a given number (e.g., N=6) of light radiation sources.

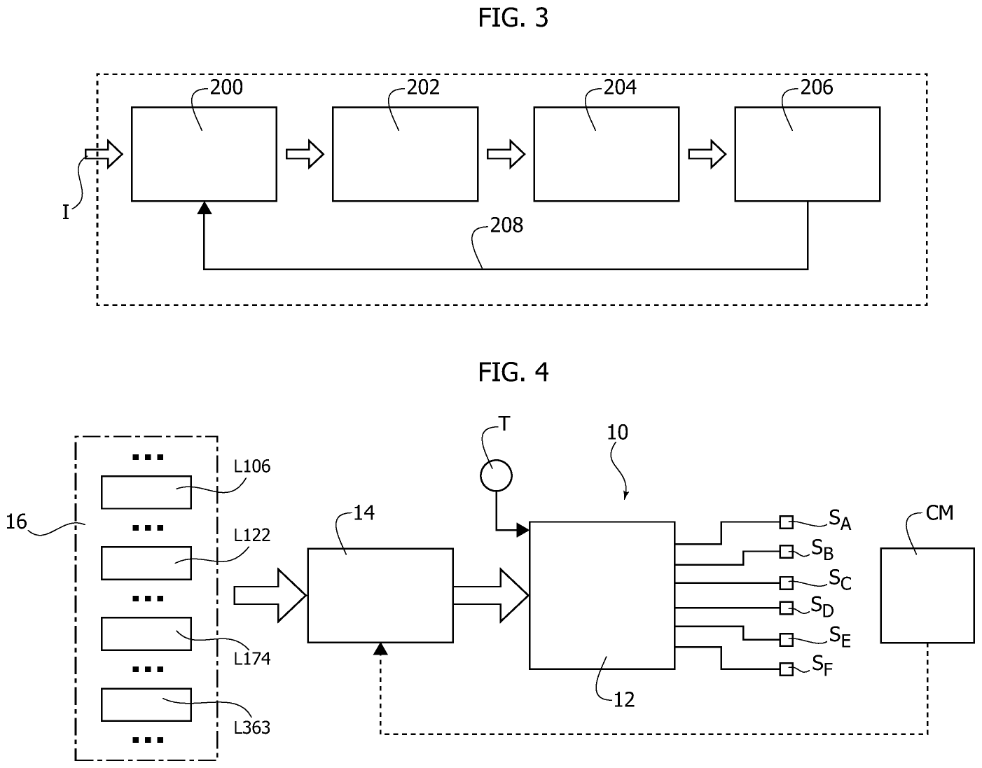

On the basis of such an observation, one or more examples may envisage actions as exemplified in the blocks of the flowchart in FIG. 3.

In one or more examples, these actions are adapted to be performed repeatedly at subsequent time intervals or frame.

These time intervals may identify different lighting modes of a given scene. For example, with reference to a DMX512 standard, the actions exemplified in the diagram of FIG. 3 may be repeated with a frequency of 44 Hz.

In the flowchart of FIG. 3, block 200 identifies the possible selection by a light designer of one or more optical filters and corresponding light intensity values, generally denoted as I, which the operator would have employed to light the scene in a certain way by using (conventional) optical filters such as gelatins.

In summary (of course, by way of example only), it is possible to consider the four filters L106, L122, L363, L174 listed in the Table above: as previously stated, the number of the traditional optical filters may be chosen as desired.

Block 202 represents the determination (e.g., via calculations or optionally by resorting to a table such as a LUT) of corresponding conversion coefficients (which may be adjustable, as detailed in the following) indicative of flux intensity ratios of a plurality of color channels.

When applied as a “digital filter” to a lighting fixture including, e.g., six color channels, the weighting coefficients enable generating by combination a colored light radiation corresponding to the light radiation which may be produced by using a given conventional optical filter or gelatin. In other words, the optical filter may be seen as the expression of one (single) line of the Table above.

Block 202 may therefore be considered as corresponding to the generation (for one or more optical filters) of the coefficients listed in the lines of the Table above.

Block 204 in FIG. 3 exemplifies an action of further processing (also including the values of intensity I defined by the user for the respective individual digital filters) a plurality of digital filters, to estimate six final (combination) drive parameters adapted to be used to generate radiations A, B, C, D, E, F by the circuitry or driver 12 to be described in the following with reference to FIG. 4, while block 206 exemplifies the procedure which (in a fashion known in itself) keeps the ratio between the flux intensities of the various radiations constant, therefore preventing undesirable color drifts of the combined radiation.

Block 204 may therefore be seen as adapted to receive input data referring to at least two digital filters, i.e., by applying the mathematical formulae adopted in the following, to receive two sets of data, wherein the value of intensity I may also be equal to zero:

I1*(α1, β1, γ1, δ1, θ1, μ1)

I2*(α2, β2, γ2, δ2, θ2, μ2).

As stated in the foregoing, the sequence of actions 200, 204, 206 is adapted to be repeated, as exemplified by the return line denoted as 208, at different time intervals.

In this respect, the action denoted as 202 is adapted to be implemented for a plurality of filters (e.g., L106, L122, L363, L174) in parallel, therefore giving the operator the possibility (e.g., with an action exemplified by block 200 in FIG. 3) to select different combinations of filters such as L106, L122, L363, L174 (with operations similar to the previous usage by the operator of traditional optical filters) to correspondingly vary the light radiation obtained by combination.

One or more examples may therefore be implemented in a fixture 10 including a given number of color channels (for example, N=6 color channels) corresponding to respective solid-state electrically-powered light radiation sources, e.g., LED sources, denoted as S_{A}, S_{B}, S_{C}, S_{D}, S_{E} and S_{F}.

With reference to what has been stated in the foregoing, those sources may be sources S_{A}, S_{B}, S_{C}, S_{D}, S_{E} and S_{F} having respective emission wavelengths, corresponding to respective color points in a color space, e.g., color points A, B, C, D, E, and F in FIG. 1.

The sources S_{A}, S_{B}, S_{C}, S_{D}, S_{E} and S_{F} may have a respective driver 12 (of a kind known in itself) associated thereto, which is adapted to set (and to keep, by compensating drift phenomena due to temperature, for example) certain given flux intensity ratios of the radiation emitted by the various sources S_{A}, S_{B}, S_{C}, S_{D}, S_{E} and S_{F} as a function of respective weighting coefficients provided by a processing (conversion or mapping) module 14.

FIG. 4 also symbolically shows, as T, a feature of detecting the (junction) temperature of sources S_{A}, S_{B}, S_{C}, S_{D}, S_{E} and S_{F}, which is adapted to be used for the procedure which (in a manner known in itself) keeps a constant ratio among the luminous flux intensities emitted by the various sources S_{A}, S_{B}, S_{C}, S_{D}, S_{E} and S_{F}, thereby countering undesirable color drifts of the emitted combined radiation.

As exemplified herein, module 14 is adapted to be coupled to a control interface 16, whereon a user may express (also as regards the respective flux intensity values) a selection of color filters (for example, with reference to the examples in the foregoing, color filters L106, L122, L363, L174), with module 14 being configured to operate as an optical filter/digital filter converter, adapted to match each choice expressed by the user through interface 16 with a corresponding set of coefficients, which are sent to the driver 12 of lighting fixture 10. Thanks to the conversion (or mapping) carried out by module 14, the user is enabled to reproduce the action of traditional optical filters (e.g., gelatins) with corresponding color channels (digital filters).

In this respect, the examples are not limited to specific procedures through which a user may express his selection via control interface 16.

In one or more examples, interface 16 may be configured to receive at input corresponding signals of optical filter selection, which may be generated in different ways such as (the list is exemplary and non-limiting): signals produced by acting on the keys of a console or other keyboard device, which may be fixed or portable, signals read from a recording device, and so on.

Also as regards the implementation of conversion module 14 it is possible to resort to a wide choice of solutions, which may range, e.g., from a memory implemented as a look-up table or LUT (in practice, a table which is similar to the Table above, which stores the correspondence between a certain number of optical filters L106, L122, L174, L363 or the like and respective sets of drive (weighting) parameters of sources S_{A}, S_{B}, S_{C}, S_{D}, S_{E} e S_{F}) to more sophisticated solutions, which may be implemented, e.g., via software, wherein such correspondence is achieved via conversion procedures which are based on optionally (adaptively) adjustable conversion parameters, and/or with the possibility of updating such parameters “on the air.”

The possible usage of a memory consisting in a look-up table (LUT) may involve various steps such as, for instance:

employing a LUT to know how to separately reproduce the individual digital filters (block 202 of FIG. 3), and

a further processing (which additionally takes into account intensity I, defined by the user, for the respective individual digital filters) to estimate the final drive parameters (e.g., six combination parameters of four digital filters) to be sent to the drive circuitry 12 (block 204).

For example, in one or more examples, a certain number of DMX (Digital MultiPlex) channels, e.g., DMX512, may be defined (action 200) by associating a corresponding digital filter to each DMX channel.

A relevant aspect of one or more examples may consist of the possibility of controlling the intensity of each such color channel (independently from the others and simultaneously) from 0% to 100% of relative intensity (e.g., as previously stated, by resorting to a traditional dimming technique which is included in the drive circuitry 12, according to known criteria).

In one or more examples, on the basis of algorithms and assuming the presence of N color channels (digital filter, with N=6 in the presently considered example, wherein the presence is assumed of six sources S_{A}, S_{B}, S_{C}, S_{D}, S_{E} e S_{F}), it is possible to define a vector Φᵢ with six scalar elements (coefficients) Φᵢ=(αᵢ, βᵢ, γᵢ, δᵢ, θᵢ, μᵢ) and i=1, 2, 3, 4.

As previously discussed with reference to FIG. 3, at a specific instant t, the user may define (e.g., at block 200 of FIG. 3) a certain number of digital filters, e.g., four, which may be represented as (αᵢ, βᵢ, γᵢ, δᵢ, θᵢ, μᵢ), i=1, . . . , 4, with respective intensities Iᵢ being associated to each optical filter and being adapted to take values ranging from 0% to 100%, defined as scalar values Ψᵢ(t).

This originates a sort of additional digital filter, which is adapted to dynamically vary as a function of the intensities Iᵢ so that the resulting combined radiation Ψ_{Tot}(t) emitted by fixture 10 may be expressed by the formula:

$${\sum }_{i = 1}^{4} {Ψ}_{i} ( t ) \cdot {Φ}_{i} ( t ) = {\sum }_{i = 1}^{4} {Ψ}_{i} ( t ) \cdot {( \begin{matrix}α ( t ) \\ β ( t ) \\ γ ( t ) \\ δ ( t ) \\ θ ( t ) \\ μ ( t )\end{matrix} )}_{i} = {( \begin{matrix}α ( t ) \\ β ( t ) \\ γ ( t ) \\ δ ( t ) \\ θ ( t ) \\ μ ( t )\end{matrix} )}_{Tot} = {Ψ}_{T o t} ( t ) .$$

As previously stated in the discussion of the Table above, these coefficients identify flux intensity values expressed as flux intensity ratios so that the resulting radiation Ψ_{Tot(t)} will be normalized to a maximum scalar value at instant t, because the respective value must not exceed 100% (DMX value equal to 255).

In other words, always in symbolical algorithmic terms:

Ψₒᵤₜ=Ψ_{Tot}/max(α_{Tot}, β_{Tot}, γ_{Tot}, δ_{Tot}, θ_{Tot}, μ_{Tot})

wherein max(.) denotes the maximum operator and, in this instance as well, the time dependency (t) is omitted for reasons of simplicity.

Therefore, one or more examples support the implementation of a feature of “dynamic” digital filter, adapted to perform a smooth passage (transition) from a combined light radiation having given color characteristics to a combined light radiation having different color characteristics, enabling therefore to properly reproduce the behavior of a traditional system.

As stated in the foregoing, the value of number N of the color channels of the digital filter (in this instance equal to six) and of number M of optical filters or gelatins reproduced by a digital filter (in instance equal to four) is merely exemplary, because either of the numbers may be chosen with any integer value at least equal to 2.

The conversion module 14 (and the corresponding interface 16) may either be integrated in the fixture 10 or may be implemented externally of the fixture 10, e.g., in a console, with an optional updating possibility, e.g., via software, optionally provided on-the-air.

This aspect reveals the possibility of employing, for the implementation of interface 16, a so-called App. This may offer both the possibility of selectively varying the settings of the system and the possibility of sharing, among a plurality of users, specific filter selections or adjustments.

Moreover, it will be appreciated that sources S_{A}, S_{B}, S_{C}, S_{D}, S_{E} e S_{F} may either be individual sources, having one radiation generator, or multiple sources, including a plurality of radiation generators having similar emission characteristics (e.g., similar emission wavelength and emission spectrum width—FWHM).

In this respect, the examples do not present any particular problem if the need is felt to employ, within each color channel (digital filter), light radiation generators having strictly identical features (e.g., as regards emission wavelength and spectrum width—FWHM), e.g., generators belonging the same binning class. This also enables the usage of one and the same value of PWM duty cycle to adjust such generators.

In one or more examples, it is possible to perform, e.g., with a colorimeter CM (which is known in itself, and which may optionally be integrated into a mobile device such as a smart phone), a measurement of the characteristics of the individual digital filters whereof the fundamental data (Cx/Cy and the flux ratios) are known, the possibility being given of carrying out proper corrections thereon: having corrected the basic colors, the resulting color will be corrected correspondingly.

In this regard, it is also possible that the individual digital filters are a subset of Ψout, and therefore the individual digital filter equals Ψout when Ψi has three zeroes and a value different from zero.

It is therefore possible to emit notification signals indicative of the fact that the system is not operating as desired, and/or to use such color measurement data to adjust the apparatus (e.g., as regards the conversion parameters implemented in module 14), the optional possibility being given of taking into account and compensating the possible ageing of the light radiation sources S_{A}, S_{B}, S_{C}, S_{D}, S_{E} e S_{F}.

One or more examples may envisage the possible implementation of module 14 as a circuit with artificial neural network, adapted to “learn” the coefficients of optical filter/digital filter conversion as a function of the measurements performed on the resulting light radiation.

One or more examples may concern a control device (e.g., 14, 16) for lighting apparatus comprising a plurality of electrically-powered light radiation sources (e.g., S_{A}, S_{B}, S_{C}, S_{D}, S_{E}, S_{F}) activatable to emit light radiations of different colors and produce a combined light radiation (e.g., Ψₒᵤₜ), wherein the luminous flux intensities of the light radiation sources of the plurality of electrically-powered light radiation sources are adjustable to vary the color (and as previously stated, the intensity) of the combined light radiation.

A control device as exemplified herein may comprise:

a user interface (e.g., 16) configured to receive optical filter selection signals (e.g., L106, L122, L124, L363), wherein the optical filter selection signals admit (i.e., are combinable into) a plurality of user-selectable combinations adapted to produce respective colors of the combined light radiation,

a conversion module (e.g., 14) configured to convert the optical filter selection signals into respective sets of luminous flux intensity values of the light radiation sources of the plurality of electrically-powered light radiation sources, wherein the plurality of user-selectable combinations are converted (by the conversion module) into a respective plurality of respective combinations of luminous flux intensities of the light radiation sources of the plurality of electrically-powered light radiation sources (so that the luminous flux intensities of the light radiation sources of the plurality of electrically-powered light radiation sources are adjusted by the conversion module) to vary the color of the combined light radiation as a function of user-selected combinations of the optical filter selection signals out of the plurality of user-selectable combinations adapted to produce respective colors of the combined light radiation.

In a control device as exemplified herein, with the electrically-powered light radiation sources arranged in a first number of light radiation emission channels activatable to emit light radiations of different colors, the user interface may be configured to receive a second number of optical filter selection signals, wherein:

each of the first number and the second number may be at least equal to two, and/or

the first number may be different from the second number, and/or

the first number and the second number may be equal to six and four, respectively.

In a control device as exemplified herein, the conversion module may be configured to convert the optical filter selection signals into respective sets of luminous flux intensity values of the light radiation sources in the plurality of electrically-powered light radiation sources.

This may take place, for example, thanks to the fact that the conversion module may be configured to convert the optical filter selection signals into respective sets of luminous flux intensity values of the light radiation sources of the plurality of electrically-powered light radiation sources, by converting the optical filter selection signals into respective sets of ratios of luminous flux intensity values of the light radiation sources in the plurality of electrically-powered light radiation sources.

In a control device as exemplified herein, configured to perform a function of dynamic digital filter:

the user interface (16) may be configured to receive the optical filter selection signals having associated (coupled) therewith respective user-variable intensity values,

the conversion module may be configured to convert the optical filter selection signals into respective sets of luminous flux intensity values of the light radiation sources of the plurality of electrically-powered light radiation sources, the respective sets of luminous flux intensity values and the color of the combined light radiation being variable as a function of the respective user-variable intensity values.

In a control device as exemplified herein, the user interface may comprise an app in a mobile communication equipment.

A lighting apparatus as exemplified herein (e.g., 10, 14, 16) may comprise:

a plurality of electrically-powered light radiation sources configured to emit light radiations of different colors and produce a combined light radiation (e.g., Ψₒᵤₜ),

drive circuitry (e.g., 12) of the plurality of electrically-powered light radiation sources, the drive circuitry being configured to adjust the luminous flux intensities of the light radiation sources of the plurality of electrically-powered light radiation sources to vary the color of the combined light radiation,

a control device (e.g., 14, 16) as exemplified herein, having the conversion module coupled to the drive circuitry to provide the drive circuitry with the respective combinations of luminous flux intensities of the light radiation sources of the plurality of electrically-powered light radiation sources, and to vary the color of the combined light radiation as a function of user-selected combinations of the optical filter selection signals out of the plurality of user-selectable combinations adapted to produce respective colors of the combined light radiation.

In a lighting apparatus as exemplified herein, the plurality of electrically-powered light radiation sources may comprise solid-state light radiation sources, optionally LED light radiation sources.

In a lighting apparatus as exemplified herein, the drive circuitry may comprise a compensation feature (e.g., T) to counter temperature-induced variations of the ratios of luminous flux intensity values of the light radiation sources of the plurality of electrically-powered light radiation sources.

In a lighting apparatus as exemplified herein, the control device:

may be at least partly incorporated into the drive circuitry, or

may be located remotely of the drive circuitry, optionally in a control console of the lighting apparatus.

A method of operating a control device as exemplified herein may comprise:

subsequently receiving, at the user interface, user-selected combinations of the optical filter selection signals out of the plurality of user-selectable combinations adapted to produce respective colors of the combined light radiation,

converting at the conversion module the user-selected combinations of the optical filter selection signals subsequently received at the user interface into respective sets of luminous flux intensities of the light radiation sources of the plurality of electrically-powered light radiation sources.

As exemplified herein, the conversion module may actually be configured to convert the optical filter selection signals into respective sets of luminous flux intensity values of the light radiation sources of the plurality of electrically-powered light radiation sources (S_{A}, S_{B}, S_{C}, S_{D}, S_{E}, S_{F}):

by converting the plurality of user-selectable combinations into a respective plurality of combinations of luminous flux intensities of the light radiation sources of the plurality of electrically-powered light radiation sources, and

by adjusting the luminous flux intensities of the light radiation sources of the plurality of electrically-powered light radiation sources to originate respective sets (of values) of luminous flux intensities of the light radiation sources of the plurality of electrically-powered light radiation sources, to vary the color of the combined light radiation as a function of combinations of the user-selected optical filter selection signals out of the plurality of user-selectable combinations, adapted to produce respective colors of the combined light radiation.

A method as exemplified herein may comprise:

receiving at the user interface at least one test combination of the optical filter selection signals out of the plurality of user-selectable combinations adapted to produce respective colors of the combined light radiation,

detecting (e.g., CM) the color of the combined light radiation produced by the plurality of electrically-powered light radiation sources as a function of the test combination of the optical filter selection signals, and measuring an offset of the color detected with respect to a target color for the combined light radiation, and

producing an output signal indicative of the measured offset.

As previously stated, this may take place, e.g., thanks to a colorimeter CM (optionally integrated into a mobile equipment such as a smart phone) adapted to detect the characteristics of the individual digital filters whereof the fundamental data are known (Cx/Cy and the flux ratios), which enables:

on one hand, detecting a color offset detected with respect to a target color for the combined light radiation, and producing an output signal indicative of the measured offset,

on the other hand, implementing proper corrections on the basic colors, consequently correcting the resulting combined color.

A method as exemplified herein may therefore comprise:

providing the conversion module with a set of adjustable conversion parameters to convert the optical filter selection signals into respective sets of luminous flux intensity values of the light radiation sources of the plurality of electrically-powered light radiation sources,

adjusting conversion parameters in the set of adjustable conversion parameters in the conversion module to reduce the measured offset.

A computer program product as exemplified herein is loadable into the memory of at least one processing unit (for example, module 14) and may include software code portions implementing a method as exemplified herein when the product is run on the at least one processing unit.

Without prejudice to the basic principles, the implementation details and the examples may vary, even appreciably, with respect to what has been described herein by way of non-limiting example only, without departing from the extent of protection.

Such extent of protection is defined by the appended claims.

1-13. (canceled)

14. A control device for lighting apparatus comprising a plurality of electrically-powered light radiation sources activatable to emit light radiations of different colors and produce a combined light radiation, wherein luminous flux intensities of the light radiation sources of said plurality of electrically-powered light radiation sources are adjustable to vary the color of said combined light radiation,
wherein the control device comprises:
a user interface configured to receive optical filter selection signals, wherein said optical filter selection signals are combinable in a plurality of user-selectable combinations adapted to produce respective colors of said combined light radiation,
a conversion module configured to convert said optical filter selection signals into respective sets of luminous flux intensity values of said light radiation sources of said plurality of electrically-powered light radiation sources, wherein the conversion module is configured to convert said plurality of user-selectable combinations into a respective plurality of combinations of luminous flux intensities of the light radiation sources of said plurality of electrically-powered light radiation sources and adjust the luminous flux intensities of the light radiation sources of said plurality of electrically-powered light radiation sources to vary the color of said combined light radiation as a function of user-selected combinations of said optical filter selection signals out of said plurality of user-selectable combinations adapted to produce respective colors of said combined light radiation.

15. The control device of claim 14, wherein, with said electrically-powered light radiation sources arranged in a first number of light radiation emission channels activatable to emit light radiations of different colors, said user interface is configured to receive a second number of optical filter selection signals, wherein:
each of said first number and said second number is at least equal to two, and/or
said first number is different from said second number, and/or
said first number and said second number are equal to six and four, respectively.

16. The control device of claim 14, wherein said conversion module is configured to convert said optical filter selection signals into respective sets of luminous flux intensity values of said light radiation sources of said plurality of electrically-powered light radiation sources by converting said optical filter selection signals into respective sets of ratios of luminous flux intensity values of said light radiation sources of said plurality of electrically-powered light radiation sources.

17. The control device of claim 14, wherein:
said user interface is configured to receive said optical filter selection signals having coupled therewith user-variable intensity values (I),
said conversion module is configured to convert said optical filter selection signals into respective sets of luminous flux intensity values of said light radiation sources of said plurality of electrically-powered light radiation sources, said respective sets of luminous flux intensity values and the color of said combined light radiation variable as a function of said user-variable intensity values.

18. The control device of claim 14, wherein said user interface comprises an app in a mobile communication equipment.

19. A lighting apparatus, comprising:
a plurality of electrically-powered light radiation sources configured to emit light radiations of different colors and produce a combined output light radiation,
drive circuitry for said plurality of electrically-powered light radiation sources, the drive circuitry configured to adjust the luminous flux intensities of the light radiation sources of said plurality of electrically-powered light radiation sources to vary the color of said combined light radiation,
the control device according to claim 14 having said conversion module coupled to said drive circuitry to provide said drive circuitry with said respective combinations of luminous flux intensities of the light radiation sources of said plurality of electrically-powered light radiation sources to vary the color of said combined light radiation as a function of user-selected combinations of said optical filter selection signals out of said plurality of user-selectable combinations adapted to produce respective colors of said combined light radiation.

20. The lighting apparatus of claim 19, wherein said plurality of electrically-powered light radiation sources comprise solid state light radiation sources or LED light radiation sources.

21. The lighting apparatus of claim 19, wherein said drive circuitry comprises a compensation feature to counter temperature-induced variations of the ratios of luminous flux intensity values of said light radiation sources of said plurality of electrically-powered light radiation sources.

22. The lighting apparatus of claim 19, wherein the control device is:
at least partly incorporated to the drive circuitry, or
located remotely of the drive circuitry or in a control console of the lighting apparatus.

23. A method of operating the control device according to claim 14, the method comprising:
receiving at said user interface user-selected combinations of said optical filter selection signals out of said plurality of user-selectable combinations adapted to produce respective colors of said combined light radiation,
converting at said conversion module said user-selected combinations of said optical filter selection signals subsequently received at said user interface into respective sets of luminous flux intensity values of said light radiation sources of said plurality of electrically- powered light radiation sources.

24. The method of claim 23, further comprising:
receiving at said user interface at least one test combination of said optical filter selection signals out of said plurality of user-selectable combinations adapted to produce respective colors of said combined light radiation,
detecting a color of said combined light radiation produced by said plurality of electrically-powered light radiation sources as a function of said test combination of said optical filter selection signals and measuring an offset of the color detected with respect to a target color for said combined light radiation, and
producing an output signal indicative of said measured offset.

25. The method of claim 24, further comprising:
providing in said conversion module a set of adjustable conversion parameters to convert said optical filter selection signals into respective sets of luminous flux intensity values of said light radiation sources of said plurality of electrically-powered light radiation sources, and
adjusting conversion parameters in said set of adjustable conversion parameters in said conversion module to reduce said measured offset.

26. A computer program product loadable into the memory of at least one processor unit and including a software code portion that implements the method of claim 23 when the product is run on said at least one processor unit.
